(19) United States
(12) Patent Application Publication
(10) Pub. No.: US 2025/0059418 A1
(43) Pub. Date: Feb. 20, 2025

(54) WASH-RESISTANT COPOLYMER

(71) Applicant: ARKEMA FRANCE, COLOMBES (FR)

(72) Inventor: Quentin PINEAU, Serquigny (FR)

(73) Assignee: ARKEMA FRANCE, COLOMBES (FR)

(21) Appl. No.: 18/723,317

(22) PCT Filed: Dec. 22, 2022
(86) PCT No.: PCT/FR2022/052480

§ 371 Date: Jun. 21, 2024

(30) Foreign Application Priority Data
Dec. 23, 2021 (FR) FR2114452

(51) Int. Cl. C09J 177/06; C08G 69/40; C09J 5/06

(52) U.S. Cl. CPC C09J 177/06; C08G 69/40; C09J 5/06

(57) ABSTRACT

A copolymer having amide structural elements and polyether structural elements and containing at least one structural element A, at least one structural element B and at least one structural element C, wherein: structural element A is an aliphatic amide repeat unit containing 10 or more carbon atoms, structural element B is an aliphatic amide repeat unit selected from a structural element obtained from at least one amino acid, a structural element obtained from at least one lactam, and a structural element X2.Y2, structural element B containing from 6 to 36 carbon atoms; structural element A being different from structural element B, structural element C is a repeat unit of the formula X3.Y3 obtained from the polycondensation of at least one polyethylene glycol diamine and/or at least one polypropylene glycol diamine designated X3 and having a molecular weight of between 200 and 1000 and a linear aliphatic dicarboxylic acid designated Y3.

The present invention relates to a copolymer for the production of a heat-sensitive adhesive, in particular a web, a film, granules, a filament, a grid, a powder or a suspension.

It also relates to said heat-sensitive adhesives and to the use thereof in the textile industry, especially for the production and joining of flexible materials.

The bonding or flocking of inscriptions or shapes onto garments is thus known in the field of textiles, and for sportswear in particular. Flocking can be defined as the application of a thin film on a textile surface. The film may be made of polyurethane, polyvinyl or polyester and the textile may be nylon, polyester, cotton or Lycra. The film is coated with an adhesive, then heat-transferred to the textile surface. This transfer can be carried out using a press or an iron at temperatures of between 150° C. and 200° C.

There is an ongoing search for adhesives that can be used at temperatures below 150° C. so as to reduce energy costs. A further aim is to be able to flock delicate textiles and to be able to use films that are less temperature-resistant, for example polyurethane films.

In addition, the flocked garment will be expected to withstand multiple wash cycles at 40° C., or even at 60° C.

In order not to stiffen the flocked garment, the adhesive used also needs to be flexible. Ideally, it is characterized by a modulus close to that of the textile to be flocked.

These adhesives can also be used to join the soles of shoes, especially sports shoes. In this technical field, great flexibility is required and the adhesive must not make the sole rigid once joined.

Thermoplastic polyurethanes (TPUs) are used in the textile industry as heat-sensitive adhesives for seamless joining. They possess properties of flexibility or suppleness in particular. Nevertheless, they have the drawback of not withstanding washing, especially machine washing, especially above 60° C. They are also difficult to use.

Some copolyamides can withstand washing up to 90° C. and are easy to use. However, they are not sufficiently flexible or are too rigid.

PEBAs are copolymers that contain amide structural elements and polyether structural elements but lack thermal adhesive properties.

There is accordingly a real need for adhesives having the aforementioned properties.

The inventors have discovered a novel copolymer that meets each of these requirements.

### BRIEF DESCRIPTION OF THE INVENTION

The present invention thus provides a copolymer having amide structural elements and polyether structural elements and containing at least one structural element A, at least one structural element B and at least one structural element C, wherein:
structural element A is an aliphatic repeat unit selected from a structural element obtained from at least one amino acid, a structural element obtained from at least one lactam, and a structural element X1.Y1 obtained from the polycondensation of at least one linear aliphatic diamine designated X1 and at least one linear aliphatic dicarboxylic acid designated Y1, and mixtures thereof,
   structural element A containing 10 or more carbon atoms,
structural element B is an aliphatic repeat unit selected from a structural element obtained from an amino acid, a structural element obtained from a lactam, and a structural element X2.Y2 obtained from the polycondensation of:
   at least one diamine designated X2, said diamine being selected from a linear or branched aliphatic diamine, a cycloaliphatic diamine and a mixture thereof, and
   at least one dicarboxylic acid designated Y2, said diacid being selected from an aliphatic diacid and a cycloaliphatic diacid,
      structural element B containing from 6 to 36 carbon atoms, advantageously from 6 to 20 carbon atoms,
      structural element A being different from structural element B,
structural element C is a repeat unit of the formula X3.Y3 obtained from the polycondensation of at least one polyethylene glycol diamine or polypropylene glycol diamine designated X3 and having a molecular mass of between 200 and 1000 g·mol⁻¹ and a linear aliphatic dicarboxylic acid designated Y3,
   structural element A representing at least 30% by weight of the copolymer,
   the melting temperature being between 75 and 130° C., as measured by DSC (differential scanning calorimetry) according to standard ISO 11357-3 (2013),
   the melt flow index (MFI) being between 5 and 200 cm³/10 min, measured at 160° C. under a load of 2.16 kg, as determined according to standard ISO 1133-1 (2011), and
   the film tensile modulus being less than 200 MPa, as determined according to standard ISO 178 (2010).

### DETAILED DESCRIPTION OF THE INVENTION

Other features, aspects, objects, and advantages of the present invention will become even more clearly apparent on reading the description that follows.

It is specified that the expressions “from . . . to . . . ” and “between . . . and . . . ” used in the present description should be understood as including each of the limits mentioned.

The nomenclature used to define the polyamides is described in standard ISO 1874-1:1992, “Plastics-Polyamide (PA) molding and extrusion materials-Part 1: Designation”, in particular on page 3 (Tables 1 and 2). In the present description, polyalkylene ether diamines are referred to by the abbreviation of the corresponding polyalkylene ether diol. For example, the abbreviation “PPG” denotes polypropylene ether diamine.

### Copolymer

Polyamide (homopolyamide or copolyamide) is for the purposes of the invention understood as meaning the condensation products of lactams, amino acids and/or diacids with diamines.

The copolymer according to the invention results from the polycondensation of at least one precursor of structural element A with at least one precursor of structural element B and with at least one precursor of structural element C.

Structural element A is an aliphatic repeat unit selected from a structural element obtained from at least one amino acid, a structural element obtained from at least one lactam, and a structural element X1.Y1 obtained from the polycondensation of at least one linear aliphatic diamine designated X1 and at least one linear aliphatic dicarboxylic acid designated Y1, and mixtures thereof, structural element A containing 10 or more carbon atoms.

When the aliphatic repeat unit A is obtained from a structural element derived from an amino acid, it may be selected from 10-aminodecanoic acid, 10-aminoundecanoic acid, 11-aminoundecanoic acid, 12-aminododecanoic acid, and derivatives thereof, especially N-heptyl-11-aminoundecanoic acid.

When the aliphatic repeat unit A is a structural element derived from a lactam, it may be selected from decanolactam, undecanolactam, and lauryllactam.

When the repeat unit A corresponds to the formula X1.Y1, the precursor of X1 may be selected from linear aliphatic diamines of the formula H₂N—(CH₂)ₐ—NH₂ selected from decanediamine (a=10), undecanediamine (a=11), dodecanediamine (a=12), tridecanediamine (a=13), tetradecanediamine (a=14), hexadecanediamine (a=16), octadecanediamine (a=18), and octadecenediamine (a=18).

The precursor of Y1 may be selected from linear aliphatic diacids of formula HOOC—(CH₂)_{b}—COOH selected from sebacic acid (b=10), undecanedioic acid (b=11), dodecanedioic acid (b=12), brassylic acid (b=13), tetradecanedioic acid (b=14), hexadecanedioic acid (b=16), octadecanedioic acid (b=18), and octadecenedioic acid (b=18).

Preferably, structural element A is obtained from a structural element selected from decanolactam, 11-aminoundecanoic acid, lauryllactam, the structural element designated 10.10 obtained from decanediamine and sebacic acid, and the structural element designated 10.12 obtained from decanediamine and dodecanedioic acid.

Structural element B is an aliphatic repeat unit selected from a structural element obtained from at least one amino acid, a structural element obtained from at least one lactam, and a structural element X2.Y2 obtained from the polycondensation of:
at least one diamine designated X2, said diamine being selected from a linear or branched aliphatic diamine, a cycloaliphatic diamine, and a mixture thereof, and
at least one dicarboxylic acid designated Y2, said diacid being selected from an aliphatic diacid, a cycloaliphatic diacid, and a mixture thereof,
   structural element B containing from 6 to 36 carbon atoms, advantageously from 6 to 20 carbon atoms.

When repeat unit B is obtained from an amino acid, this may be selected from 9-aminononanoic acid, 10-aminodecanoic acid, 10-aminoundecanoic acid, 11-aminoundecanoic acid and 12-aminododecanoic acid, and derivatives thereof, especially N-heptyl-11-aminoundecanoic acid.

When repeat unit B is obtained from a lactam, this may be selected from pyrrolidinone, 2-piperidinone, caprolactam, enantholactam, caprylolactam, pelargolactam, decanolactam, undecanolactam, and lauryllactam.

When repeat unit B corresponds to the formula X2.Y2, the precursor of X2 may be selected from linear or branched aliphatic diamines and cycloaliphatic diamines.

When the diamine is aliphatic and linear, it may in particular be of the formula H₂N—(CH₂)_{d}—NH₂; the diamine is selected from butanediamine (d=4), pentanediamine (d=5), hexanediamine (d=6), heptanediamine (d=7), octanediamine (d=8), nonanediamine (d=9), decanediamine (d=10), undecanediamine (d=11), dodecanediamine (d=12), tridecanediamine (d=13), tetradecanediamine (d=14), hexadecanediamine (d=16), octadecanediamine (d=18), and octadecenediamine (d=18).

When the diamine is aliphatic and branched, it may contain one or more methyl or ethyl substituents on the main chain. For example, it may be selected from 2,2,4-trimethylhexane-1,6-diamine, 2,4,4-trimethylhexane-1,6-diamine, 1,3-diaminopentane, 2-methylpentane-1,5-diamine, and 2-methyloctane-1,8-diamine.

When the diamine is cycloaliphatic, it is preferably selected from piperazine, an aminoalkyl piperazine, bis(3,5-dialkyl-4-aminocyclohexyl) methane, bis(3,5-dialkyl-4-aminocyclohexyl) ethane, bis(3,5-dialkyl-4-aminocyclohexyl) propane, bis(3,5-dialkyl-4-aminocyclohexyl) butane, bis(3-methyl-4-aminocyclohexyl) methane (BMACM or MACM), p-bis(aminocyclohexyl) methane (PACM) and isopropylidenedi(cyclohexylamine) (PACP). It may also contain the following carbon backbones: norbornylmethane, cyclohexylmethane, dicyclohexylpropane, di(methylcyclohexyl), and di(methylcyclohexyl) propane. A nonexhaustive list of these cycloaliphatic diamines is given in the publication “Cycloaliphatic 20) Amines” (Encyclopedia of Chemical Technology, Kirk-Othmer, 4th edition (1992), pp. 386-405).

When repeat unit B corresponds to the formula X2.Y2, the precursor of Y2 may be selected from linear or branched aliphatic diacids and cycloaliphatic diacids.

When the diacid of formula HOOC—(CH₂)ₑ—COOH is aliphatic and linear, it is preferably selected from succinic acid (e=4), pentanedioic acid (e=5), adipic acid (e=6), heptanedioic acid (e=7), octanedioic acid (e=8), azelaic acid (e=9), sebacic acid (e=10), undecanedioic acid (e=11), dodecanedioic acid (e=12), brassylic acid (e=13), tetradecanedioic acid (e=14), hexadecanedioic acid (e=16), octadecanedioic acid (e=18), and octadecenedioic acid (e=18).

When the diacid is cycloaliphatic, it may contain the following carbon backbones: norbornylmethane, cyclohexylmethane, dicyclohexylmethane, dicyclohexylpropane, di(methylcyclohexyl), and di(methylcyclohexyl) propane.

With regard to the calculation of the number of carbon atoms in structural element B, this carbon number is the sum total of the number of carbon atoms of the units constituting the structural element. For example, for the structural element 6, i.e. the structural element resulting from the polycondensation of caprolactam, the carbon number is 6. For the structural element 66, for example, i.e. the structural element resulting from the polycondensation of hexanediamine and adipic acid, the carbon number is 12.

Preferably, structural element B is obtained from a structural element selected from caprolactam, the structural element designated 6.6 obtained from hexanediamine and adipic acid, and the structural element designated 10.10 obtained from decanediamine and sebacic acid.

Structural elements A and B are different from one another.

Structural element C is of the formula X3.Y3 and is obtained from the polycondensation of at least one polyethylene glycol diamine or polypropylene glycol diamine designated X3 and having a molecular mass of between 200 and 1000 and a linear aliphatic dicarboxylic acid designated Y3.

The precursor of unit X3 is a polyethylene glycol or polypropylene glycol with diamine chain ends obtained by cyanoethylation and hydrogenation of α,ω-dihydroxylated aliphatic polyethylene or polypropylene sequences termed polyethylene ether diol or polypropylene ether diol.

The precursor of unit X3 has a molecular mass of between 200 and 1000 g·mol⁻¹, preferably between 300 and 600 g·mol⁻¹.

The list of dicarboxylic acids mentioned above for unit Y2 of structural element B applies also to unit Y3.

Advantageously, the polyalkylene ether diamine of the copolymer according to the invention is selected from diamines derived from PPG, PEG or a PEG-PPG mixture. The polyalkylene ether diamines may in particular be selected from the commercial products sold under the Elastamine® or Jeffamine® brands by Huntsman, or Baxxodur® by BASF.

The copolymer according to the invention can be obtained by reacting the polyalkylene ether diamine precursor of structural element X3, the polyamide precursors of structural elements A and B, and a chain-limiting diacid precursor of structural element Y3. A polymer is obtained having essentially polyether blocks and polyamide blocks of variable length, but also structural elements resulting from the random reaction between the different precursors distributed randomly (statistically) along the polymer chain.

Structural element A represents at least 30% by weight of the copolymer according to the invention, preferably between 30% and 70%, and more particularly between 30% and 50% by weight relative to the total weight of the copolymer.

Preferably, structural element B represents between 10% and 40% and in particular between 15% and 30% by weight relative to the total weight of the copolymer.

Preferably, structural element C represents at least 30% by weight of the copolymer relative to the total weight of the copolymer according to the invention, preferably between 30% and 70%, and more particularly between 30% and 50% by weight relative to the total weight of the copolymer.

Particularly preferably, the copolymer according to the invention comprises between 30% and 50% by weight of structural element A, between 10% and 40% by weight of structural element B, and between 30% and 50% by weight of structural element C, relative to the total weight of the copolymer, the sum total of the contents of structural elements A, B, and C being 100%.

The copolymer according to the invention may be made up of 3 monomers A, B, and C, and thus be a terpolymer.

The copolymer may also be a tetrapolymer and contain 4 different structural elements, having for example 2 different structural elements B according to the formula A/B1/B2/C or for example 2 different structural elements A according to the formula A1/A2/B1/C.

The copolymer may also be a pentapolymer and contain 5 different structural elements, having for example 2 different structural elements A and 2 different structural elements B according to the formula A1/A2/B1/B2/C.

Preferably, the copolymer according to the invention is selected from 10.12/6/PPG400.12, 11/6/PPG400.6, 12/6/PPG400.6, 10.10/6/PPG400.10, 11/6/6.6/PPG400.6, 11/12/6/6.6/PPG400.6, and 11/10.10/PPG400.10.

The melting temperature of the copolymer according to the invention is between 75 and 130° C., preferably between 9° and 120° C. The melting temperature is measured by DSC (differential scanning calorimetry) according to standard ISO 11357-3 (2013).

The melt flow index (MFI) is between 5 and 200 cm³/10 min, measured at 160° C. under a load of 2.16 kg as determined according to standard ISO 1133-1 (2011), preferably between 10 and 100 cm³/10 min, in particular between 15 and 50 cm³/10 min, at 160° C. under a load of 2.16 kg as determined according to standard ISO 1133-2 (2011).

The film tensile modulus of the copolymer according to the invention is less than 200 MPa, as determined according to standard ISO 178 (2010). Preferably, the modulus is between 50 and 180 MPa, and more particularly between 90 and 160 MPa.

### Process for Preparing the Copolymer

The copolymer containing amide structural elements and polyether structural elements can be prepared by the process according to which:
in a first step, the precursors of the amide structural elements are prepared by polycondensation of
the diamine(s);
the dicarboxylic acid(s); and
the comonomer(s) selected from lactams and α,ω-aminocarboxylic acids, if used;
in the presence of a chain limiter Y3 selected from dicarboxylic acids; then
in a second step, reacting the resulting precursors of the amide structural elements with the polyalkylene ether diamine(s) in the presence of a catalyst.

The two-step general method of preparation for the copolymers of the invention is known and is described for example in French patent FR 2 846 332 and European patent EP 1 482 011.

The reaction for forming the precursors of the amide structural elements is customarily carried out between 18° and 300° C., preferably at from 200 to 290° C.; the pressure in the reactor is established at between 5 and 30 bar and maintained for approximately 2 to 3 hours. The pressure is then gradually reduced and the excess water then distilled off.

Once the polyamide having carboxylic acid end groups has been prepared, the polyetherdiamine and a catalyst are then added. The polyether may be added in one or more portions, as may the catalyst. According to an advantageous form, the polyetherdiamine is first added: the reaction of the NH₂ end groups of the polyether with the COOH end groups of the polyamide commences, with the formation of amide bonds and elimination of water. As much water as possible is removed from the reaction medium by distillation, then the catalyst is introduced to complete the linking of the polyamide blocks and the polyether blocks. This second step is carried out with stirring, preferably under a vacuum of at least 15 mmHg (2000 Pa), at a temperature such that the reagents and the copolymers obtained are in a molten state. For example, this temperature may be between 10° and 400° C. and more commonly between 20° and 300° C. The reaction is monitored by measuring the torque exerted by the molten polymer on the stirrer or by measuring the electrical power consumed by the stirrer. The end of the reaction is determined by the target torque or power value.

One or more antioxidants may be added during the synthesis, for example those commercially available under the Irganox® 1010, Irganox® 245 or Irganox 1098° names.

It is also possible to consider the process for preparing the copolymer where all the monomers are added to the water at the start, i.e. in a single step, so as to effect the polycondensation of:
the diamine(s);
the dicarboxylic acid(s);
the other polyamide comonomer(s), if used;
a chain limiter Y3 selected from dicarboxylic acids; and
the polyalkylene ether diamine(s);
in the presence of a catalyst for the reaction between the amide structural elements and the amide structural elements.

Advantageously, said dicarboxylic acid serves as chain limiter Y3, which is introduced in excess relative to the stoichiometry of the diamine(s).

Advantageously, a strong acid such as phosphoric acid, hypophosphorous acid or phosphorous acid is used as catalyst.

The mixture is heated to a temperature of 270° C. and the reaction medium then depressurized. The polycondensation is then carried out while flushing with nitrogen. The reaction is completed under vacuum, at a pressure of between 20 and 50 mbar. The polycondensation temperature is to be adjusted according to the melting temperature of the monomers used.

### Composition

The invention also relates to a composition predominantly comprising at least one copolymer according to the invention and at least one additive.

Preferably, the additives are present in the composition in a content of between 0.10% and 5%, preferably between 0.25% and 2%, by weight relative to the total weight of the composition.

The additives are selected in particular from stabilizers and dyes.

For example, the stabilizer may be a UV stabilizer, an organic stabilizer or more generally a combination of organic stabilizers, such as a phenol-type antioxidant (for example of the Irganox® 245, 1098 or 1010 type from Ciba-BASF), a phosphite-type antioxidant (for example Irgafos® 126 from Ciba-BASF), and possibly even other stabilizers, such as a HALS, which stands for Hindered Amine Light Stabilizer (for example Tinuvin® 770 from Ciba-BASF), a UV absorber (for example Tinuvin® 312 from Ciba) or a phosphorus-based stabilizer. It is also possible to use amine-type antioxidants, such as Naugard® 445 from Crompton or else polyfunctional stabilizers, such as Nylostab S-EED® from Clariant.

This stabilizer may also be an inorganic stabilizer, such as a copper-based stabilizer. Examples of such inorganic stabilizers include halides and acetates of copper or those of other metals such as silver. These copper-based compounds are typically combined with halides of alkali metals, in particular potassium.

Dyes are preferably present in a proportion of from 0% to 1.5%, especially from 0.5% to 1%, by weight relative to the total weight of the composition. Stabilizers are preferably present in a proportion of from 0% to 2%, especially from 0.5% to 1%, by weight relative to the total weight of the composition.

Advantageously, the composition of the invention is free of plasticizers and of BBSA in particular.

Advantageously, the composition according to the invention comprises:
predominantly at least one copolymer as defined above and
   between 0% and 2% by weight of at least one additive selected from a stabilizer, a dye, and a mixture thereof, relative to the total weight of the composition.

The composition may also comprise a second polymer, preferably selected from a polyester, a polyurethane or a polyamide. Preferably, the composition comprises between 0.25% and 15% by weight of at least one polymer selected from a polyester, a polyurethane, and a polyamide, relative to the total weight of the composition.

The composition according to the invention can be produced by processes known to those skilled in the art. In particular, it is possible to add the additives to the copolymer of the invention during or after the synthesis. When the addition is carried out after synthesis, it can be done in particular by melt mixing (for example in an extruder).

The copolymer as defined above or the composition according to the invention as defined above is useful as a heat-sensitive adhesive of the HMA (hot melt adhesive) type.

HMAs are thermoplastic adhesives that are designed to be melted by heating and that, when applied to two parts of a textile, allow, after cooling, edge-to-edge bonding of the two parts, thus avoiding a seam connecting the two parts.

Advantageously, the heat-sensitive adhesive as defined above is used in the form of a web, a film, granules, a filament, a grid, a powder or a suspension. The copolymer or the composition of the invention can thus be easily shaped using processes known for this purpose.

The thickness of the heat-sensitive adhesive is preferably from 5 to 200 μm (equivalent to 5 to 200 g/m² according to a different unit of measurement), in particular from 5 to 100 μm. Depending on the form in which the adhesive is used, the preferred thickness may vary. For example, the thickness of a web is preferably between 5 and 30 μm, the thickness of a film is preferably between 10 and 100 μm, and the thickness of a grid is preferably between 10 and 50 μm.

The heat-sensitive adhesive in powder form may be used in the form of different powder types characterized by a particle diameter ranging from:
more than 0 to 80 microns;
more than 0 to 120 microns;
from 80 to 180 microns;
from 80 to 200 microns; or
from 200 to 500 microns.

In the case of the suspension, the above powder is suspended, especially in water, in particular at a concentration of from 40% to 50%.

Advantageously, said adhesive as defined above, especially in the form of a film, has a thickness of from 10 to 200 μm, preferably a thickness of from 20 to 100 μm, and more particularly between 30 and 60 μm.

When in the form of a film, said heat-sensitive adhesive as defined above may consist of a single layer or be in a multilayer form, that is to say comprising at least two layers.

For example, said adhesive in the form of a film having a thickness of 40 μm may be a film consisting of a single layer of 40 μm or of 2 layers of 20 μm, or of as many layers as the thickness of the film divided by the thickness of a layer.

According to another aspect, the present invention relates to the use of the copolymer or of the composition as defined above, as a heat-sensitive adhesive.

According to another aspect, the present invention relates to the use of the copolymer or of the composition as defined above for the production of a heat-sensitive adhesive, in particular a web, a film, granules, a filament, a grid, a powder or a suspension.

Advantageously, the heat-sensitive adhesive as defined above is used in the textile industry, especially for the production of flexible materials, especially the bonding or flocking of textiles, especially sports textiles.

The adhesive according to the invention is preferably used for the flocking of garments.

According to another aspect of the invention, the adhesive according to the invention can be used for joining the soles of shoes, especially the soles of sports shoes.

The examples that follow serve to illustrate the present invention, but are not in any way limiting.

### EXAMPLES

### Sample Preparation

The example copolymers are prepared in a single-step process.

For copolymer 1, the monomers and the additive were mixed with water and with phosphoric acid as catalyst. The reaction medium was heated to 230° C. and then depressurized. The polycondensation is then carried out while flushing with nitrogen. The reaction medium is then placed under vacuum at a pressure of between 20 and 50 mbar.

Polymers 2 to 4 were prepared according to a similar method.

The formulation of the copolymers is detailed in Table 1 below.

TABLE 1

| | Ex. 1 | Ex. 2 | Ex. 3 | Ex. 4 |
|---|---|---|---|---|
| | inventive | comparative | comparative | comparative |
| Caprolactam | 20 | 30 | — | 12 |
| 11- | 40 | — | — | 1 |
| Aminoundecanoic | | | | |
| acid | | | | |
| Lactam 12 | — | 50 | — | 27.9 |
| Ethylenediamine | — | — | 4.2 | — |
| Piperazine | — | 5.5 | 15.1 | — |
| Adipic acid | 9.9 | — | — | — |
| Sebacic acid | — | — | 9.8 | 10.3 |
| Dodecanedioic | — | 14.5 | — | — |
| acid | | | | |
| Pripol 1013¹ | — | — | 67.9 | — |
| D400² | 30.1 | — | — | — |
| PTMG 1000 | — | — | — | 49.8 |
| Stearic acid | — | — | 3 | — |
| Irganox 1098 | 0.1 | 0.1 | — | — |
| Irganox 1010 | — | — | — | 0.2 |
| Tego antifoam N | — | — | 0.05 | — |

¹Pripol 1013 denotes a fatty acid dimer sold by Croda.
²D400 denotes a polypropylene glycol diamine having a molecular mass of 400 g · mol⁻¹ sold under the Jeffamine D400 brand name by Huntsman.

### Measurement of Sample Properties

The following physicochemical properties of these copolymers and compositions were measured.

The melting temperature is measured by DSC (differential scanning calorimetry) according to standard ISO 11357-3 (2013).

The melt flow index (MFI) is measured according to standard ISO 1133-1 (2011) at 160° C. under a load of 2.16 kg.

The film tensile modulus is measured according to standard ISO 178 (2010).

The physicochemical properties of the copolymers tested are collated in Table 2 below.

TABLE 2

| | Ex. 1 | Ex. 2 | Ex. 3 | Ex. 4 |
|---|---|---|---|---|
| | inventive | comparative | comparative | comparative |
| Tm (° C.) | 105 | 106 | 85 | 112 |
| MFI | 26 | 30 | 250 | 15 |
| (cm³/10 min) | | | | |
| Modulus (MPa) | 140 | 330 | 44 | 80 |

Copolymer 2 does not meet the condition for the modulus. It is too rigid and does not allow a flexible flocked textile to be obtained.

Copolymer 3 does not meet the condition for the MFI. It is too fluid.

### Evaluation of the Samples

The copolymers are transformed into a 45 μm film by extrusion blow-molding.

The film thus obtained is placed between a nylon textile fabric and a polyurethane film, the assembly is then joined at 147° C. for 5 seconds under a pressure of 1.5 bar.

The samples are evaluated by means of two separate tests:

In a first test, the samples are subjected to 15 machine wash cycles at 40° C. followed by drying at 80° C., and the adhesion of the film is visually evaluated between each cycle.

The results are collated in Table 3.

TABLE 3

| | Ex. 1 | | |
|---|---|---|---|
| | inventive | Ex. 3 comparative | Ex. 4 comparative |
| Wash-resistant | Resistant | Delamination after | Delamination after |
| | | 5 cycles | 10 cycles |

In the second test, the samples are subjected to 10 machine wash cycles at 60° C. followed by drying at 80° C., and the adhesion of the film is visually evaluated between each cycle.

The results are collated in Table 4.

TABLE 4

| | Ex. 1 | | |
|---|---|---|---|
| | inventive | Ex. 3 comparative | Ex. 4 comparative |
| Wash-resistant | Resistant | Delamination after | Delamination after |
| | | 2 cycles | 5 cycles |

The results show that the copolymer according to the invention is able to withstand washing, even at 60° C.

1. A copolymer having amide structural elements and polyether structural elements and containing at least one structural element A, at least one structural element B and at least one structural element C, wherein:
structural element A is an aliphatic amide repeat unit selected from a structural element obtained from at least one amino acid, a structural element obtained from at least one lactam, and a structural element X1.Y1 obtained from the polycondensation of at least one linear aliphatic diamine designated X1 and at least one linear aliphatic dicarboxylic acid designated Y1,
structural element A containing 10 or more carbon atoms,
structural element B is an aliphatic amide repeat unit selected from a structural element obtained from at least one amino acid, a structural element obtained from at least one lactam, and a structural element X2.Y2 obtained from the polycondensation of:
at least one diamine designated X2, said diamine being selected from a linear or branched aliphatic diamine, a cycloaliphatic diamine, and a mixture thereof, and
at least one dicarboxylic acid designated Y2, said diacid being selected from an aliphatic diacid and a cycloaliphatic diacid,
structural element B containing from 6 to 36 carbon atoms,
structural element A being different from structural element B,
structural element C is a repeat unit of the formula X3.Y3 obtained from the polycondensation of at least one polyethylene glycol diamine and/or at least one polypropylene glycol diamine designated X3 and having a molecular weight of between 200 and 1000 g·mol⁻¹ and a linear aliphatic dicarboxylic acid designated Y3,
structural element A representing at least 30% by weight relative to the total weight of the copolymer,
the melting temperature being between 75 and 130° C., as measured by DSC (differential scanning calorimetry) according to standard ISO 11357-3 (2013),
the melt flow index being between 5 and 200 cm3/10 min, measured at 160° C. under a load of 2.16 kg, determined according to standard ISO 1133-1 (2011), and
the film tensile modulus being less than 200 MPa, as determined according to standard ISO 178 (2010).

2. The copolymer as claimed in claim 1, wherein the copolymer comprises at least 30% by weight relative to the total weight of the copolymer of structural elements C.

3. The copolymer as claimed in claim 1, wherein the copolymer comprises between 30% and 50% by weight of structural element A, between 10% and 40% by weight of structural element B, and between 30% and 50% by weight of structural element C, relative to the total weight of the copolymer, the sum total of the contents of structural elements A, B, and C being 100%.

4. The copolymer as claimed in claim 1, wherein thee structural element A is obtained from a structural element selected from decanolactam, 11-aminoundecanoic acid, lauryllactam, the structural element designated 10.10 obtained from decanediamine and sebacic acid, and the structural element designated 10.12 obtained from decanediamine and dodecanedioic acid.

5. The copolymer as claimed in claim 1, wherein the structural element B is obtained from a structural element selected from caprolactam, the structural element designated 6.6 obtained from hexanediamine and adipic acid, and the structural element designated 10.10 obtained from decanediamine and sebacic acid.

6. The copolymer as claimed in claim 1, wherein the copolymer is selected from 10.12/6/PPG400.12, 11/6/PPG400.6, 12/6/PPG400.6, 10.10/6/PPG400.10, 11/6/6.6/PPG400.6, 11/12/6/6.6/PPG400.6, and 11/10.10/PPG400.10.

7. An adhesive composition comprising:
predominantly at least one copolymer as defined in claim 1 and
between 0% and 2% by weight of at least one additive selected from a stabilizer, a dye, and a mixture thereof, relative to the total weight of the composition.

8. The composition as claimed in claim 7, wherein the composition comprises between 0.25% and 15% by weight of at least one polymer selected from a polyester, a polyurethane, and a polyamide, relative to the total weight of the composition.

9. The composition as claimed in claim 7, wherein the composition comes in the form of a web, a film, granules, a filament, a grid, a powder or a suspension.

10. A method of using the copolymer as defined in claim 1, as a heat-sensitive adhesive.

11. The method as claimed in claim 10, further comprising joining of flexible materials or joining soles of shoes.
